(19) United States
(12) Patent Application Publication
(10) Pub. No.: US 2002/0047545 A1
(43) Pub. Date: Apr. 25, 2002

(54) Particle accelerator

(76) Inventors: Alain Paulus, Thimister (BE); Jacques Gouffaux, Liege (BE)

Correspondence Address: BROWDY AND NEIMARK, P.L.L.C., 624 NINTH STREET, NW, SUITE 300, WASHINGTON, DC, 20001-5303, US

(21) Appl. No.: 09/908,972

(22) Filed: Jul. 20, 2001

(30) Foreign Application Priority Data
Jul. 20, 2000 (BE) PCT/BE00/00087
Dec. 22, 2000 (BE) PCT/BE00/00158

(51) Int. Cl. H01J 7/24

(52) U.S. Cl. 315/111.61

(57) ABSTRACT

The invention relates to a particle accelerator. The accelerator comprises a chamber (h) made of conducting material having a central axis; an anode (a) connected electrically to the chamber along the central axis; a cathode (b) housed in the chamber along the central axis; an insulating element (c) connecting the cathode to the chamber, the insulating element comprising several sections separated by electrodes (k1 to k6). The insulator lies inside the chamber (h) along the central axis in the extension of the region formed by the anode (a) and the cathode (b).

The present invention relates to a particle accelerator, in particular an electron accelerator.

For more than 100 years, the particular properties of X-rays have been used in very varied applications. This is because this radiation has the particular feature of being able to pass through matter, the absorption rate depending both on the thickness and on the nature of the material passed through. Thus, if any object is subjected to X-ray radiation, and if a device is used making it possible to reconstruct point by point the dose level picked up behind this object, it is possible in this way to obtain information as to its internal nature, its possible defects invisible from the outside, or possible inclusions of foreign materials.

The best known application is of course medicine, but X-rays are also widely used in industry for detecting defects or foreign bodies, and in the field of security in order to examine the content of luggage or of various parcels.

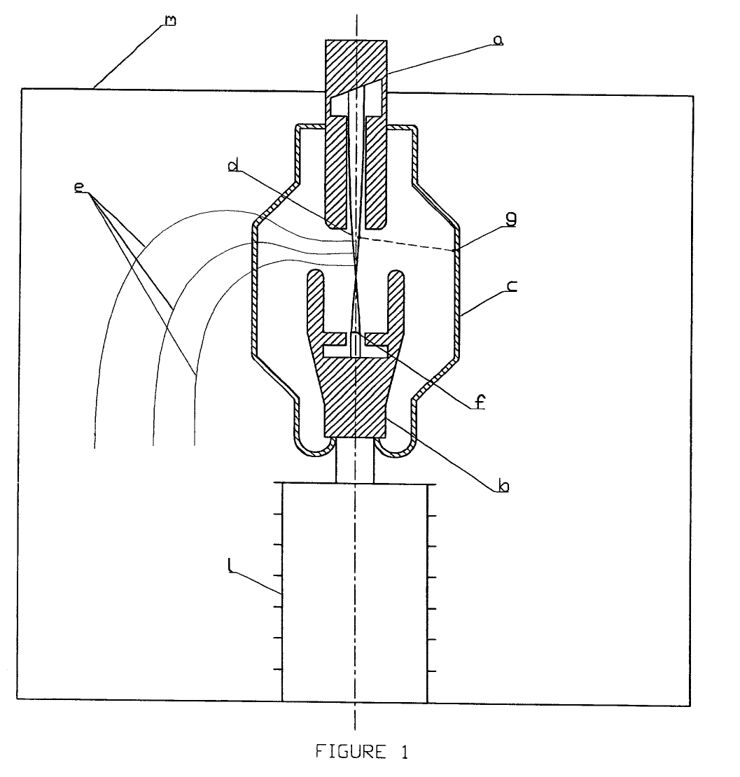

Although these techniques have considerably changed over time, the main means implemented to generate X-rays are still the same. They still comprise (FIG. 1) at least two electrodes, the anode (a) and the cathode (b), between which a high-voltage generating device (l) makes it possible to apply a high potential difference (several tens or several hundreds of kilovolts). The cathode (b) is at a negative potential with respect to the anode (a). In addition, the cathode (b) comprises a device (generally a filament (f) brought to about 2000° C.) making it possible to provide initial energy to electrons which, accelerated by the electric field, will form a beam (d) travelling at high speed in the direction of the anode (a). When these electrons (d) reach it, their sudden deceleration releases energy, the majority of which is transformed into heat, while a few percent are converted into X-ray radiation.

This device can only function if the electrons are completely free to move, hence the need for placing it in an evacuated chamber. Since this chamber physically connects the anode and the cathode, it has to have an insulator making it possible to withstand the large difference in potential existing between these two electrodes. In FIG. 1, the insulator consists of glass (c).

Furthermore, since the outer part of the system is subjected to high electric fields, it must be immersed in a liquid or gaseous insulating medium, for example, insulating oil or even pressurized sulphur hexafluoride (SF₆). This insulator is contained in a chamber (m) which is earthed.

The insulator of X-ray tubes is still one of their main weak points.

Firstly, since the vacuum in the chamber of the tube cannot be perfect, the electron beam (d) may encounter residual molecules and ionize them, thus creating “vagabond” electrons (g) which may collect on the insulator (c) and charge it electrically, the properties of this insulator preventing these charges from being removed quickly. The electric field on the insulator (c) may then locally reach values which are high enough to make the cathode current unstable by the grid effect, and sometimes even destroy the insulator.

Secondly, the potential between the anode (a) and the cathode (b) is never uniformly distributed. FIG. 1 shows the approximate location of the equipotential lines (e) in this particular configuration. It can be seen that the majority of these equipotentials are located opposite the anode-cathode space. Since the electric field on the insulator is therefore not uniform, it is necessary to provide it with great length in order to allow it to withstand the dielectric stress to which it is subjected.

Since the market is demanding increasingly powerful generators in smaller volumes, various techniques have been developed in order to progress in this direction.

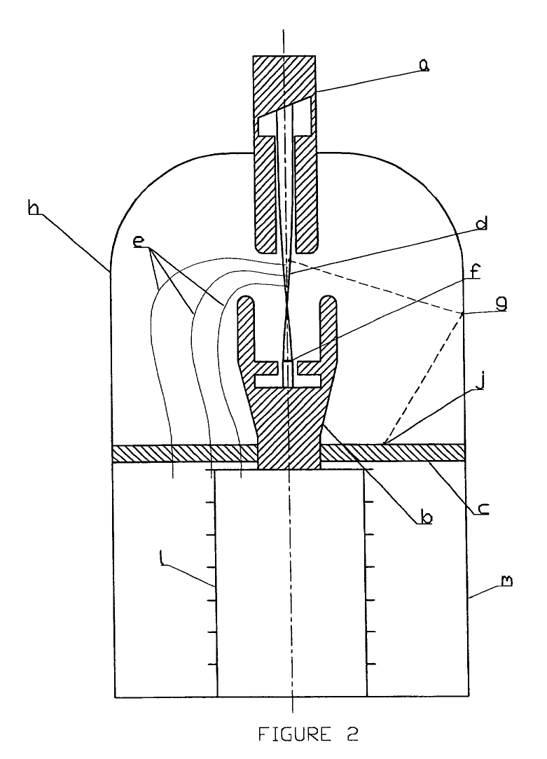

A first improvement (FIG. 2) consists in moving the insulator (c) into a region where it is less exposed to vagabond electrons. In this case, the insulator is no longer in the anode-cathode space, but it consists of a disc surrounding the cathode. The chamber of the tube is then closed by an earthed metal jacket (h). It can be seen that the electrons (g) produced by ionization of the molecules passing through the beam can no longer reach the insulator (c) directly. However, they can still strike the jacket (h) and generate secondary electrons (j) which can reach the insulator (c). This solution is certainly an improvement with respect to the basic configuration of FIG. 1. However, analysis of the equipotentials (e) shows that the voltage is not always uniformly distributed, which prevents high potentials from being obtained in small sizes. Furthermore, the insulator is not always perfectly sheltered from vagabond electrons, which means having to resort to complicated and expensive solutions in order to protect it.

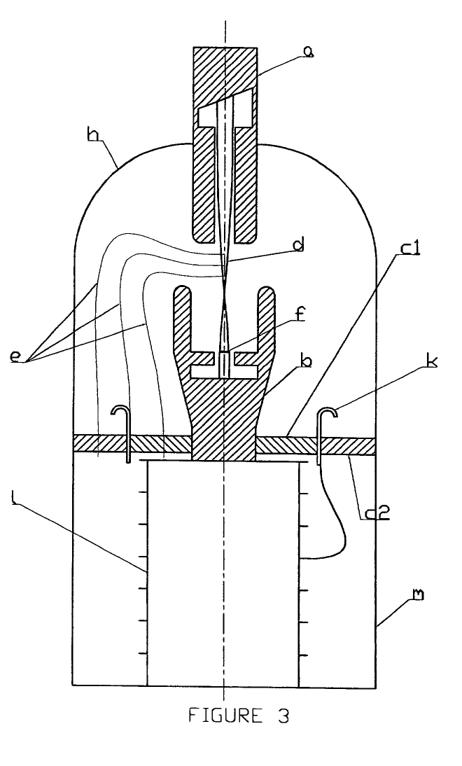

Another improvement with respect to the latter (U.S. Pat. No. 5,426,345, FIG. 3) consists in dividing the insulator into two parts (c1, c2) separated by an intermediate electrode (k), connected to a potential chosen so as to optimize the distribution of the voltage along this insulator. This intermediate potential can be obtained, for example, by producing a resistive divider, or even by connecting this electrode to one of the stages of a voltage multiplier (l). this solution makes it possible to reduce the size of the insulator, although it remains quite large, but does not at all solve the problem of vagabond electrons.

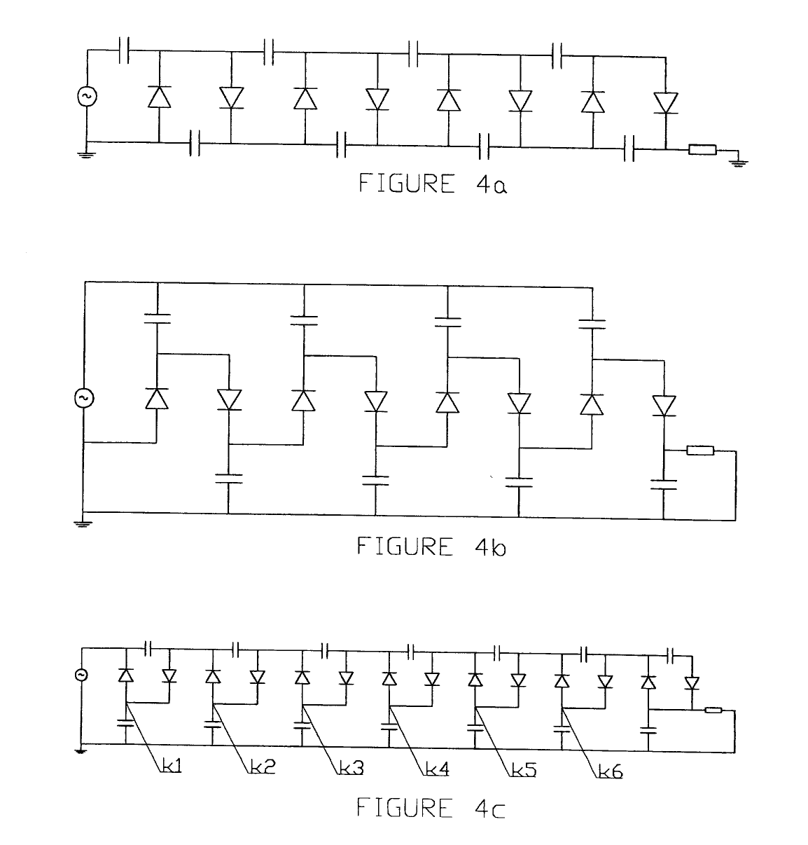

The voltage multiplier (l) is a voltage generator produced according to the well-known Cockroft-Walton scheme. It consists of an assembly of a certain number of stages formed by diodes and capacitors, and in which the voltage increases progressively on passing from one stage to the other. FIGS. 4a, 4b and 4c show some possible configurations for producing this type of scheme (in the case of a 4-stage multiplier). Numerous variants can be found in the literature.

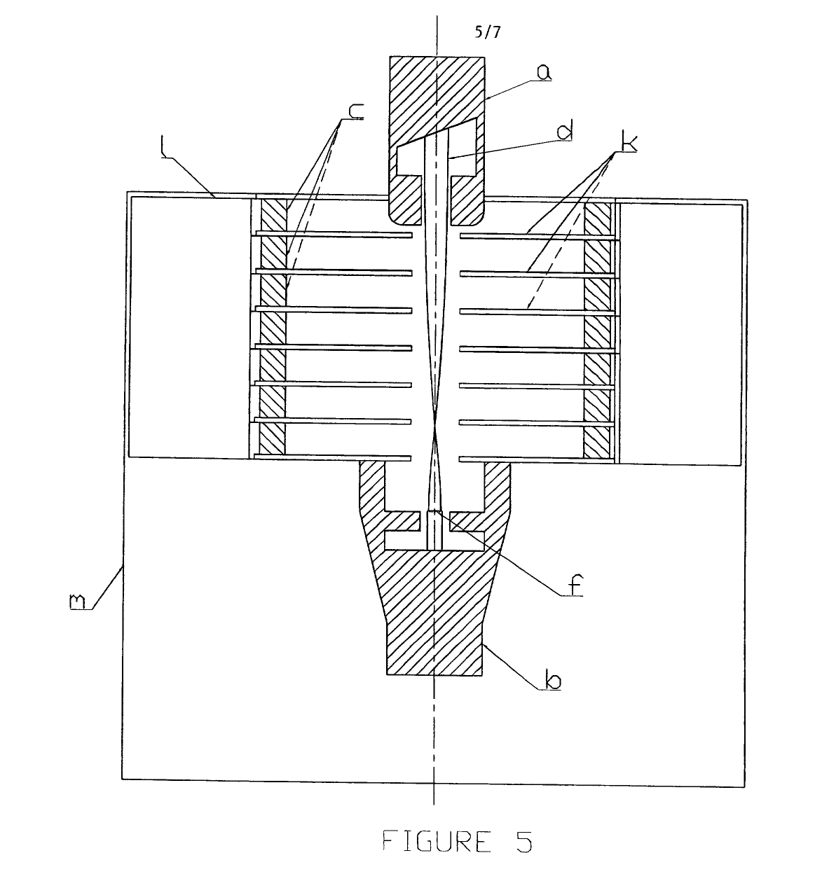

The use of such a multiplier has made it possible to produce another solution (U.S. Pat. No. 5,191,517, FIG. 5). It consists in leaving the insulator (c) in the anode-cathode space, and in dividing it into as many sections as there are stages in the multiplier. The intermediate electrodes (k) separating these sections are then connected to the various potentials present along the multiplier. The equipotentials (not shown) are in fact lines perpendicular to the axis of the tube and passing through the electrodes (k). This solution therefore makes it possible to obtain a virtually ideal voltage distribution, therefore an extremely small insulator length. However, the problem of vagabond electrons remains complete, and furthermore, since the multiplier (l) is on the outer part of the insulator, the outer diameter of the unit increases rapidly as soon as the power to be provided becomes large, which is a handicap in the majority of applications.

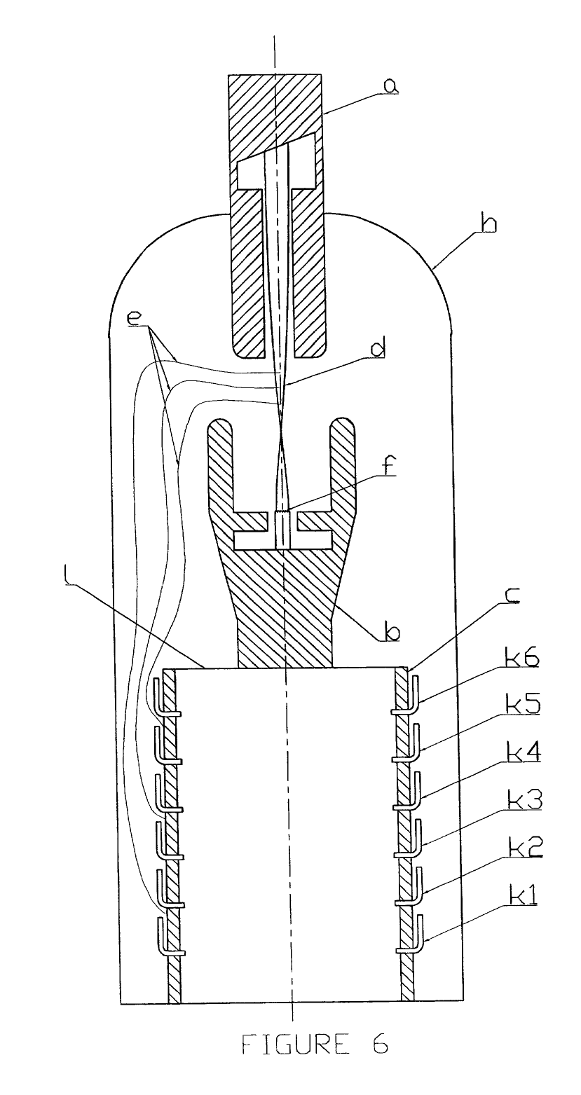

The solution provided by the invention is as follows (FIG. 6): The insulator (c) is placed in the extension of the cathode. More specifically, the unit formed by the insulator and the voltage multiplier lies inside the chamber (h) along the central axis in the extension of the region formed by the anode and the cathode (b). It is thus located in a region where the probability that it is struck by a vagabond electron is considerably reduced, or even virtually zero.

An example of a voltage multiplier which can be used in the device according to FIG. 6 is illustrated in FIG. 4c. Specifically, this multiplier comprises 7 stages and illustrates schematically how the various electrodes k1 to k6 are connected to the various stages of the multiplier.

The insulator is therefore divided into as many parts as there are stages in the multiplier supplying the tube, exactly as in the embodiment illustrated in FIG. 5. The essential difference is that in the present invention, the voltage multiplier will be found inside the volume comprising the X-ray tube, which will allow an extremely large reduction in the dimensions of the unit, in particular, in the external diameter. In other words, the voltage multiplier is housed inside the insulating element.

The reason for this reduction in dimensions appears clearly on comparing FIGS. 3 and 6. In FIG. 3, showing the known solution, it can be seen that the equipotentials must be very spaced out along the radius passing through the insulator, in order to reduce the electric field to which it is subjected.

In contrast, in FIG. 6 showing the invention, it can be seen that all the regions subjected to a high electric field, that is to say where the equipotentials are very close together, are in the vacuum, and are able to support these stresses much easier. Moreover, the insulator is distributed along the multiplier, that is in a region where the equipotentials are perfectly distributed. It is this which makes it possible to produce a system of much smaller diameter than in all the existing solutions, while strongly reducing the stresses, thus increasing the reliability.

The shape of the intermediate electrodes must be carefully studied, so as to reduce as much as possible the electric field, and to provide the maximum protection against residual vagabond electrons to the insulator.

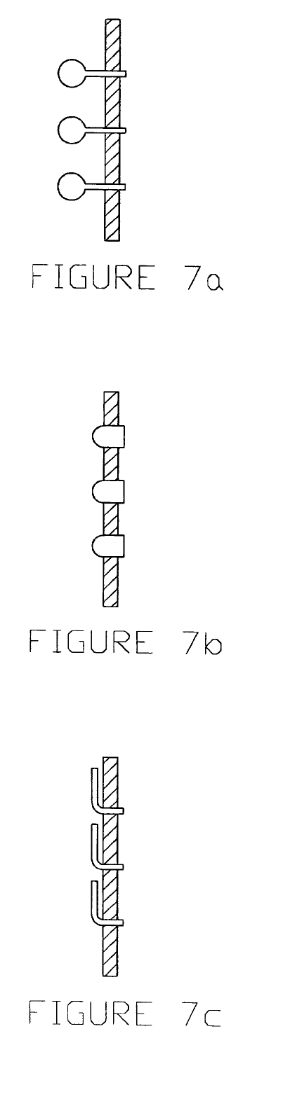

FIG. 7 (a, b, c) shows 3 examples of shapes for these electrodes. Finite element calculations show that the solution of FIG. 7c, namely the one where the electrodes each comprise a far end lying parallel to a wall of the chamber, is that which best allows the electric field to be reduced while providing optimum protection for the insulator.

This configuration has another essential advantage. Specifically, if the intermediate electrodes k1 to k6 of FIG. 6 are considered, it will be noticed that these electrodes have a capacitance with respect to the tube wall. With reference to the diagram of FIG. 4c, note that this capacitance exactly fulfils the function of the capacitors connected to earth, in the lower part of the diagram. In other words, a capacitor is formed between each electrode and earth. These capacitors can therefore be used to produce a voltage multiplier. It is therefore not necessary to place these capacitors in the multiplier itself, hence a saving in size and cost.

The present description is based on a voltage multiplier. Other equivalent techniques also come within the scope of the invention.

It is therefore possible to add that the configuration described could be used with a device other than the voltage multiplier, provided that this device allows the potential of the various intermediate electrodes to be set. It could be, for example, a resistive voltage divider, or else transformers arranged in a cascade.

1. Particle accelerator comprising:
an electrically conducting chamber (h) having a central axis;
an anode (a) connected to the chamber along the central axis;
a cathode (b) housed in the chamber along the central axis;
an insulating element (c) connecting the cathode to the chamber, the insulating element comprising several sections separated by electrodes (k1 to k6),
in which the insulator lies inside the chamber (h) along the central axis in the extension of the region formed by the anode (a) and the cathode

2. Particle accelerator according to claim 1, comprising:
a chamber (h) made of electrically conducting material having a central axis;
an anode (a) electrically connected to the chamber along the central axis;
a cathode (b) housed in the chamber along the central axis;
an insulating element (c) connecting the cathode to the chamber, the insulating element comprising several sections;
a voltage multiplier comprising several stages, each stage having a contact point at a predetermined potential; and
a series of electrodes inserted between the various sections of the insulator, each of these electrodes being connected to one of the stages of the voltage multiplier;
in which
the voltage multiplier is housed inside the insulating element; and
the unit formed by the insulator and the voltage multiplier lies inside the chamber (h) along the central axis in the extension of the region formed by the anode and the cathode (b).

3. Particle accelerator according to either of claims 1 and 2, in which each of the electrodes comprises a far end lying parallel to a wall of the chamber, thus forming a capacitor between each electrode and earth.
